(19) United States
(12) Patent Application Publication
(10) Pub. No.: US 2021/0352892 A1
(43) Pub. Date: Nov. 18, 2021

(54) MACROMOLECULAR AND NONPARTICULATE AGROCHEMICALS TO REDUCE VAPOR DRIFT

(71) Applicant: University of Utah Research Foundation, Salt Lake City, UT (US)

(72) Inventors: Hamidreza S. Ghandehari, Salt Lake City, UT (US); Kyle Isaacson, Salt Lake City, UT (US); Mark Jensen, Pleasant Grove, UT (US); Nithya Subrahmanyam, Salt Lake City, UT (US)

(21) Appl. No.: 17/044,657

(22) PCT Filed: Apr. 10, 2020
(86) PCT No.: PCT/US2020/027835

§ 371 Date: Oct. 1, 2020

Related U.S. Application Data
(60) Provisional application No. 62/832,083, filed on Apr. 10, 2019.

(51) Int. Cl. A01N 25/10; A01N 37/40; C08L 67/03

(52) U.S. Cl. CPC A01N 25/10; C08L 67/03; A01N 37/40

(57) ABSTRACT

The invention generally relates to agrochemical compositions and methods of making and using same. Specifically, the disclosed agrochemical compositions comprise high molecular weight non-polymeric residues or polymer backbones, and pesticide residues covalently attached thereto. Such compositions can be useful in, for example, controlling plant growth. This abstract is intended as a scanning tool for purposes of searching in the particular art and is not intended to be limiting of the present invention.

### BACKGROUND

A commonly used herbicide, dicamba, has a vapor pressure of 4.5 mPa at 25 ° C. and is characterized as a moderately volatile compound (Nishimura J, Gazzo K, Budd R. Environmental fate and toxicology of dicamba. California Environmental Protection Agency (2015)). As such, the use of dicamba in agricultural applications has remained limited because application techniques are limited. When dicamba is sprayed (either via aerial- or ground-spraying techniques), a non-negligible quantity of dicamba aerosolizes and is carried in the air vapor to neighboring crops or farms.

Dicamba achieved EPA approval in 1967 and is currently marketed under many trade names, including Clarity® by BASF Chemical Company, Banvel® by Arysta LifeScience, Diablo™, Vanquish® by NuFarm, and Oracle® by Gharda Chemicals. Each of the many companies provide strict instructions not to use aerial spray techniques (i.e., crop dusting) to apply the chemical, yet BASF, Monsanto, and DuPont allowed the use of ground-spraying technologies. Dicamba has been used to a minimal extent over the past several decades; however, Monsanto recently developed dicamba-resistant soybeans (a $50 B investment), which renewed interest in the herbicide. In November 2016, the EPA approved a low-volatility Monsanto formulation of dicamba, XtendiMax®, which further pushed the use of ground-spraying technologies during the 2017 season. Unfortunately, many farmers utilized old dicamba products or products from companies unapproved for spray application, resulting in substantial herbicide drift and decimation of neighboring fields. Dispute continues as to whether the low-volatility Monsanto formulations contributed to the destructive impact on over 3.1 million acres in at least 16 states. Following the drift allegations, the EPA deemed all dicamba products as “restricted use,” essentially permitting only certain applicators with special dicamba-specific training to apply the herbicide. It is yet to be determined to what level the EPA will continue to allow “over-the-top” application of dicamba products during the 2018 season, yet many states have created their own outright ban of dicamba products in 2018.

Despite the known volatility, the 2015 global dicamba market was estimated to be valued at US $321 M (Markets & Markets. Dicamba Herbicide Market by Crop Type (Cereals & Grains, Oilseeds & Pulses, and Pastures & Forage Crops), Formulation (Acid and Salt), Physical Form (Dry and Liquid), & Time of Application (Pre- and Post-Emergence)-Global Forecast to 2022 (2015)). The market is expected to grow at a CAGR of 7.3% until 2022, achieving a market size of US $521 M by 2022. Greatest growth was expected to occur in the cereals and grains segment; however, these predictions were made prior to the genetic introduction of resistance into both soybean and corn. Liquid formulation segment should dominate the dicamba herbicide market. Changing farming practices that increase reliance on genetically-modified crops will increase demand in North America.

Herbicide volatility is referred to as the movement of an herbicide from the application site due to conversion of the herbicide to a gaseous state. As such, all herbicides do not have the potential for volatility, and only certain active ingredients when combined with improper formulations exhibit volatility. Therefore, chemical manipulation of the dicamba herbicide should allow for complete reduction of volatility potential. However, current techniques have limited their attempts to reduce volatility to physical means (e.g., salt complexation, drift control additives) or via regulation of spray and weather conditions. Thus, there remains a need for formulations of dicamba and other pesticides that reduces volatility via chemical modification. These needs and others are met by the present invention.

### SUMMARY

In accordance with the purpose(s) of the invention, as embodied and broadly described herein, the invention, in one aspect, relates to macromolecular agrochemicals, methods of making same, and methods of using same in, for example, controlling plant growth.

Disclosed are compositions comprising: (a) a non-polymeric residue having a molecular weight of at least about 500 g/mol and a length of at least about 10 Angstroms; or (b) a polymer backbone, and a residue of a pesticide having a carboxylate group, wherein the residue terminates the non-polymeric residue or the polymer backbone.

Also disclosed are methods for making a disclosed composition, the method comprising reacting a macromolecule having a molecular weight of at least about 500 g/mol and a length of at least about 10 Angstroms and a pesticide having a carboxylic acid group, wherein the macromolecule has a terminal group selected from —OH and —NH₂.

Also disclosed are methods for making a disclosed composition, the method comprising reacting a polymer and a pesticide having a carboxylic acid group, wherein the polymer has a terminal group selected from —OH and —NH₂.

Also disclosed are methods for controlling plant growth in an environment, the method comprising applying an effective amount of a composition comprising: (a) a non-polymeric residue having a molecular weight of at least about 500 g/mol and a length of at least about 10 Angstroms; or (b) a polymer backbone, and a residue of an herbicide having a carboxylate group, and wherein the residue terminates the non-polymeric residue or the polymer backbone.

Also disclosed are compositions having a structure represented by a formula:

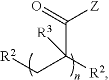

wherein n is an integer selected from 6 to 99; wherein Z is a dicamba residue; wherein R² is selected from —CO₂H and —CO₂(C1-C4 alkyl); and wherein R³ is selected from hydrogen, halogen, —NO₂, —CN, and C1-C4 alkyl.

Also disclosed are methods for making a disclosed composition, the method comprising polymerizing an acrylate monomer having a structure represented by a formula:

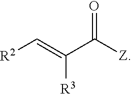

Also disclosed are methods for controlling plant growth in an environment, the method comprising applying an effective amount of a disclosed composition.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE DRAWINGS

The accompanying figures, which are incorporated in and constitute a part of this specification, illustrate several aspects and together with the description serve to explain the principles of the invention.

FIG. 1 shows a representative schematic illustrating a two-step chemical reaction involving formation of dicamba-PEG.

FIG. 2 shows a representative schematic illustrating a two-step chemical reaction involving formation of polymeric dicamba.

Additional advantages of the invention will be set forth in part in the description that follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Further, the dates of publication provided herein may be different from the actual publication dates, which can require independent confirmation.

### A. DEFINITIONS

The present invention now will be described more fully hereinafter with reference to the accompanying drawings, in which illustrative aspects of the invention are shown. In the drawings, the relative sizes of regions or features may be exaggerated for clarity. This invention may, however, be embodied in many different forms and should not be construed as limited to the aspects set forth herein; rather, these aspects are provided so that this disclosure will be thorough and complete, and will fully convey the scope of the invention to those skilled in the art.

The disclosures of all patent references cited herein are hereby incorporated by reference to the extent they are consistent with the disclosure set forth herein. As used herein in the description of the invention and the appended claims, the singular forms “a,” “an,” and “the” are intended to include the plural forms as well, unless the context clearly indicates otherwise.

As used in the specification and in the claims, the term “comprising” can include the aspects “consisting of” and “consisting essentially of”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular aspects only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in various aspects of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

References to parts by weight of a particular component in a composition, whether in the specification or subsequent claims, expresses the weight relationship between the component and any other components in the composition or article for which a part by weight is described. For example, in a composition containing 1 part by weight of component A and 2 parts by weight component B, A and B are present in a weight ratio of 1:2 and exist in this ratio regardless of whether additional components are present in the composition.

A weight percent (wt. % or wt %) of a component, unless stated specifically to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

As used herein, the term “non-polymeric residue” refers to a residue of a very large molecule, having a molecular weight of at least about 500 g/mol. Examples of non-polymeric residues include, but are not limited to, carbohydrates. In various aspects, the non-polymeric residue may have a length of at least about 10 Angstroms, at least about 15 Angstroms, at least about 20 Angstroms, at least about 25 Angstroms, at least about 30 Angstroms, at least about 35 Angstroms, at least about 40 Angstroms, at least about 45 Angstroms, at least about 50 Angstroms, at least about 55 Angstroms, at least about 60 Angstroms, at least about 65 Angstroms, or at least about 70 Angstroms, Typically, the non-polymeric residue may have at least about 10 atoms in a chain, at least about 11 atoms in a chain, at least about 12 atoms in a chain, at least about 13 atoms in a chain, at least about 14 atoms in a chain, or at least about 15 atoms in a chain.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. AGROCHEMICAL COMPOSITIONS

In one aspect, disclosed are compositions comprising: (a) a non-polymeric residue having a molecular weight of at least about 500 g/mol and a length of at least about 10 Angstroms; or (b) a polymer backbone, and a residue of a pesticide having a carboxylate group, wherein the residue terminates the non-polymeric residue or the polymer backbone.

In various aspects, the disclosed compositions allow for controlled release of the pesticide. Without wishing to be bound by theory, controlled-release technology has emerged as an alternative approach with the promise to solve the problems accompanying the use of some agrochemicals, while avoiding possible side effects with others. Such methodology, if widely used in the application of agricultural chemicals, could allow for the increased production of foodstuffs while simultaneously allowing a decrease in the amounts and types of agents used. In addition, controlled-release technology could assist in improving protection for stored grains against insect and rodent pests. It might substantially reduce the concentration required for beneficial effects and thus avoid or reduce the undesirable side effects of conventional agricultural chemicals. It might reduce the unit cost of materials applications and the expense of repeated and over application of the materials. In short, the aim of controlled-release formulation consists of protecting the supply of the reagent and to allow its automatic delivery to the target at controlled rates to maintain its concentration within an optimum concentration over a long period of time.

Controlled release may be defined as a technique or method in which active chemicals are made available to a specified target at a rate and duration designed to accomplish an intended effect. Usually, biologically active agents are administered to a target systematically or topically at a site somewhat remote from the target. This results in non-specificity and the need for periodic applications. Remote application, besides increasing the cost of treatment, often produces undesirable side effects either to the target or its environment. Controlled release allows the optimum concentration of active agents to be maintained within the system over a period of time and may allow specific targeting.

The disclosed agrochemical compositions chemically attach a pesticide to a non-polymeric residue or a polymer backbone via a degradable bond. Without wishing to be bound by theory, such an attachment can allow for the controlled-release of the pesticide onto the target.

Thus, in various aspects, the disclosed composition comprises a non-polymeric residue having a molecular weight of at least about 500 g/mol and a length of at least about 10 Angstroms and a residue of a pesticide having a carboxylate group, wherein the residue terminates the non-polymeric residue.

In a further aspect, the residue and the non-polymeric residue are linked via an anhydride or an ester. In a still further aspect, the residue and the non-polymeric residue are linked via an anhydride. In yet a further aspect, the residue and the non-polymeric residue are linked via an ester.

In a further aspect, the disclosed composition comprises a polymer backbone and a residue of a pesticide having a carboxylate group, wherein the residue terminates the polymer backbone. In a still further, the residue terminates the polymer backbone on one end of the polymer backbone. In yet a further aspect, the residue terminates the polymer backbone on both ends of the polymer backbone.

In a further aspect, the residue and the polymer backbone are linked via an anhydride or an ester. In a still further aspect, the residue and the polymer backbone are linked via an anhydride. In yet a further aspect, the residue and the polymer backbone are linked via an ester.

In various aspects, the ratio of the number of the pesticide molecules to the number of the polymer molecules is about 1:1. In a further aspect, the ratio of the number of the pesticide molecules to the number of the polymer molecules is of from about 0.5:1 to about 1:0.5, from about 0.6:1 to about 1:0.6, from about 0.7:1 to about 1:0.7, from about 0.8:1 to about 1:0.8, or from about 0.9:1 to about 1:0.9.

In various aspects, the ratio of the molecular weight of the pesticide to the molecular weight of the polymer is of from about 1:100 to about 1:3. In a further aspect the ratio of the molecular weight of the pesticide to the molecular weight of the polymer is of from about 1:75 to about 1:3, from about 1:50 to about 1:3, from about 1:25 to about 1:3, from about 1:10 to about 1:3, or from about 1:5 to about 1:3. In a still further aspect, the ratio of the molecular weight of the pesticide to the molecular weight of the polymer is of from about 1:100 to about 1:5, from about 1:100 to about 1:10, from about 1:100 to about 1:25, from about 1:100 to about 1:50, or from about 1:100 to about 1:75.

### 1. Non-Polymeric Residues

In one aspect, the disclosed compositions comprise a non-polymeric residue having a molecular weight of at least about 500 g/mol and a length of at least about 10 Angstroms. In a further aspect, the disclosed compositions comprise a non-polymeric residue having a molecular weight of at least about 500 g/mol and at least 10 atoms in a chain.

Thus, in various aspects, the non-polymeric residue has a molecular weight of from at least about 750 g/mol. In a further aspect, the non-polymeric residue has a molecular weight of from at least about 1,000 g/mol. In a still further aspect, the non-polymeric residue has a molecular weight of from at least about 1,250 g/mol. In yet a further aspect, the non-polymeric residue has a molecular weight of from at least about 1,500 g/mol. In an even further aspect, the non-polymeric residue has a molecular weight of from at least about 1,750 g/mol. In a still further aspect, the non-polymeric residue has a molecular weight of from at least about 2,000 g/mol.

In various aspects, the non-polymeric residue has a length of at least about 15 Angstroms. In a further aspect, the non-polymeric residue has a length of at least about 20 Angstroms. In a still further aspect, the non-polymeric residue has a length of at least about 25 Angstroms. In yet a further aspect, the non-polymeric residue has a length of at least about 50 Angstroms. In an even further aspect, the non-polymeric residue has a length of at least about 75 Angstroms.

In various aspects, the non-polymeric residue has at least 10 atoms in a chain. In a further aspect, the non-polymeric residue has at least 11 atoms in a chain. In a still further aspect, the non-polymeric residue has at least 12 atoms in a chain. In yet a further aspect, the non-polymeric residue has at least 13 atoms in a chain. In an even further aspect, the non-polymeric residue has at least 14 atoms in a chain. In a still further aspect, the non-polymeric residue has at least 15 atoms in a chain.

### 2. Polymer Backbones

In one aspect, the disclosed compositions comprise a polymer backbone. Examples of polymers suitable for use as the polymer backbone include, but are not limited to, polyesters, polyurethanes, and polyols, although it is envisioned that other polymers having a primary hydroxyl or amine group could also be used. In a still further aspect, the polymer backbone comprises a polyester polymer.

In a further aspect, the polymer backbone comprises a residue of a polymer having an alcohol group. In a further aspect, the polymer backbone comprises a residue of a polymer having an amine group.

In a further aspect, the polymer has a molecular weight of from about 500 g/mol to about 80,000 g/mol. In a still further aspect, the polymer has a molecular weight of from about 500 g/mol to about 60,000 g/mol, from about 500 g/mol to about 40,000 g/mol, from about 500 g/mol to about 20,000 g/mol, from about 500 g/mol to about 10,000 g/mol, from about 500 g/mol to about 5,000 g/mol, or from about 500 g/mol to about 1,000 g/mol. In yet a further aspect, the polymer has a molecular weight of from about 1,000 g/mol to about 80,000 g/mol, from about 5,000 g/mol to about 80,000 g/mol, from about 10,000 g/mol to about 80,000 g/mol, from about 20,000 g/mol to about 80,000 g/mol, from about 40,000 g/mol to about 80,000 g/mol, or from about 60,000 g/mol to about 80,000 g/mol.

In a further aspect, the polymer backbone comprises a hydrolytically unstable linkage. The most common chemical functional groups with this characteristic are esters, anhydrides, orthoesters, and amides. Chemical hydrolysis of the hydrolytically unstable backbone is the prevailing mechanism for the polymer's degradation. Examples of polymers having a hydrolytically unstable linkage include, but are not limited to polyethyleneglycol, polyvinyl alcohol, and poly(hydroxypropylmethacrylamide). Polymers having hydrolytically unstable linkages are commercially available or prepared by methods known in the art.

### 3. Pesticides

In one aspect, the disclosed compositions comprise a residue of a pesticide having a carboxylate group. Examples of pesticides include, but are not limited to, herbicides, insecticides, insect growth regulators, fungicides, rodenticides, molluscicides, avicides, bactericides, and nematicides. Pesticides are commercially available or prepared by methods known to those skilled in the art. In addition, it is envisioned that the pesticide could be chemically modified to include a carboxylate group using methods known to those skilled in the art.

In a further aspect, the pesticide is an insecticide. Examples of insecticides include, but are not limited to, abamectin, acephate, acetamipirid, afidopyropen, afoxolaner, alanycarb, aldicarb, allethrin, azamethiphos, azinphos-ethyl, azinphos-methyl, Bacillus thuringiensis, bendiocarb, benfluthrin, benfuracarb, bensultap, bifenthrin, bioallethrin, bioresmethrin, bistrifluron, broflanilide, buprofezin, butocarboxim, carbaryl, carbofuran, carbosulfan, cartap, chlorantraniliprole, chlorethxyfos, chlorfenapyr, chlorfenvinphos, chlorfluazuron, chlormephos, chloroprallethrin, chlorpyrifos, chlorpyrifos-methyl, chromafenozide, clothianidin, cyanophos, cyantraniliprole, cyclaniliprole, cycloprothrin, cyflumetofen, cyfluthrin, beta-cyfluthrin, cyhalodiamide, cyhalothrin, gamma-cyhalothrin, lambda-cyhalothrin, cypermethrin, alpha-cypermethrin, beta-cypermethrin, zeta-cypermethrin, cyphenothrin, cyromazine, deltamethrin, diacloden, diafenthiuron, diazinon, dicloromezotiaz, dichlorvos, diflubenzuron, dimefluthrin, dimethylvinphos, dinotefuran, diofenolan, disulfoton, dimethoate, emamectin-benzoate, empenthrin, endosulfan, alpha-endosulfan, EPN, esfenvalerate, ethiofencarb, ethiprole, etofenprox, etrimfos, fenitrothion, fenobucarb, fenoxycarb, fenpropathrin, fenthion, fenvalerate, fipronil, flonicamid, fluazuron, flubendiamide, flucycloxuron, flucythrinate, flufenerim, flufenoxuron, flufenprox, flumethrin, fluralaner, fluvalinate, tau-fluvalinate, fonophos, formetanate, formothion, furathiocarb, flufiprole, fluhexafon, flupyradifurone, flometoquin, halofenozide, heptafluthrin, hexaflumuron, hydramethylnon, imidacloprid, imiprothrin, isofenphos, indoxacarb, indoxacarb-MP, isoprocarb, isoxathion, kappa-bifenthrin, kappa-tefluthrin, lepimectin, lufenuron, malathion, meperfluthrin, metaflumizone, metaldehyde, methamidophos, methidathion, methacrifos, metalcarb, methomyl, methoprene, methoxychlor, methoxyfenozide, methyl bromide, metofluthrin, epsilon-metofluthrin, momfluorothrin, epsilon-momfluorothrin, monocrotophos, muscalure, nitenpyram, novaluron, noviflumuron, omethoate, oxydemeton-methyl, oxydeprofos, parathion, parathion-methyl, pentachlorophenol, permethrin, phenothrin, phenthoate, phoxim, phorate, phosalone, phosmet, phosphamidon, pirimicarb, pirimiphos-methyl, profenofos, profluthrin, prothiofos, propaphos, protrifenbute, pymetrozine, pyraclofos, pyrethrins, pyridalyl, pyrifluquinazon, pyriprole, pyrafluprole, pyriproxyfen, resmethrin, rotenone, SI-0405 (test name), sulprofos, silafluofen, spinetoram, spinosad, spiromesifen, spirotetramat, sulfoxaflor, sulfotep, SYJ-159 (test name), tebfenozide, teflubenzuron, tefluthorin, terbufos, tetrachlorvinphos, tetramethrin, d-tetramethrin, tetramethylfluthrin, tetraniliprole, thiacloprid, thiocyclam, thiodicarb, thiamethoxam, thiofanox, thiometon, tolfenpyrad, tralomethrin, transfluthrin, triazamate, trichlorfon, triazuron, triflumezopyrim, triflumuron, and vamidothion.

In a further aspect, the pesticide is an insect growth regulator. Examples of insect growth regulators include, but are not limited to, dimilin, juvenile hormone analogs such as methoprene, kinoprene, hydroprene, triprene, epofenonane, and fenoxycarb; anti juvenile hormone analogs such as precocene, ponasterone A, benzodioxoles, and ecdysone; and chitin synthesis inhibitors such as diflubenzuron, chlorfluazuron, buprofezin, penfluron, teflubenzuron, and trifluron.

In a further aspect, the pesticide is a fungicide. Examples of fungicides include, but are not limited to, TPN, azoxystrobin, isoprothiolane, iprodione, iminoctadine albesilate, iminoctadine triacetate, imibenconazole, echlomezole, oxycarboxin, captan, kresoxim-methyl, chloroneb, cyproconazole, simeconazole, wettable sulfur, thiuram, thiophanate-methyl, thifluzamide, tetraconazole, tebuconazole, triadimefon, triclofos methyl, triflumizole, triforine, tolclofos-methyl, validamycin, validamycin A, bitertanol, hydroxyisoxazole, pyributicarb, fenarimol, ferimzone, flutolanil, procymidone, propamocarb hydrochloride, propiconazole, benomyl, pencycuron, fosetyl-Al, polyoxin, polyoxin D, polyoxin D zinc salt, polycarbamate, myclobutanil, metalaxyl, mepronil, and oxine copper.

In a further aspect, the pesticide is a rodenticide. Examples of rodenticides include, but are not limited to, 2-isovalerylindan-1,3-dione, 4-(quinoxalin-2-ylamino)benzenesulfonamide, alpha-chlorohydrin, aluminium phosphines, anta, arsenics oxide, barium carbonate, bisthiosemi, brodifacoum, bromadiolone, bromethalin, calcium cyanide, chloralose, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, gamma-HCH, HCH, hydrogen cyanide, iodomethane, lindane, magnesium phosphide, methyl bromide, norbormide, phosacetim, phosphine, phosphorus, pindone, potassium arsenite, pyrinuron, scilliroside, sodium arsenite, sodium cyanide, sodium fluoroacetate, strychnine, thallium sulfate, warfarin, and zinc phosphide.

In a further aspect, the pesticide is a molluscicide. Examples of molluscicides include, but are not limited to, cupric sulfate pentahydrate, cupric stearate, aluminum sulfate, metaldehyde-tetramethyl-1,3,5,7-tetoxocane, dichloral urea-1,3-bis(2,2,2-trichloro-1-hydroxyethyl)urea, mexacarbate-4-dimethylamino-3,5-xylyl-N-methylcarbamate, methiocarb3,5-dimethyl-4-(methylthio)phenylmethyl carbamate, niclosamide-5-chloro-N-(2-chloro-4-nitrophenyl)-2-hydroxybenzamide, TBS-N-(4-bromophenyl)-2-hydroxy-3,5-dibromobenzamide, N-isobutyl-N-triphenylmethylamine, trifenmorph-N-tritylmorpholine, isopimpinellin, and 2,6-dibromo-4-(4-nitrophenylazo)phenol.

In a further aspect, the pesticide is an avicide. Examples of avicides include, but are not limited to, strychnine, DRC-1339 (3-chloro-4-methylaniline hydrochloride, Starlicide), CPTH (3-chloro-p-toluidine, the free base of Starlicide), and Avitrol (4-aminopyridine.

In a further aspect, the pesticide is a bactericide. Examples of bactericides include, but are not limited to, Dithane Z-78 (zinc ethylenebis(dithiocarbamate)), Maneb (manganous ethylene-bis(dithiocarbamate)), Thiram (bis(dimethylthiocarbamyl)-disulfide), Manzeb (zinc/manganese ethylenebisdithio-carbamate), Bisdaithane (bisdimethyldithiocarbamoylzinc ethylenebisdithiocarbamate), benzimidazole derivatives such as Benomyl (methyl 1-(butylcarbamoyl)-2-benzimidazole-carbamate) and Thiophanate-methyl (1,2-bis(3-methoxy-carbonyl-2-thioureido) benzene), as well as Vinclozolin (3-(3,5-dichlorophenyl)-5-methyl-5-vinyl-1,3-oxazolidine-2,4-dione), Iprodione (3-(3,5-dichlorophenyl)-N-isopropyl-2,4-dioxoimidazolidine-1carboxamide), Procymidone (N-(3,5-dichlorophenyl)-1,2-dimethylcyclopropane-1,2-dicarboximide), Triazine (2,4-dichloro-6-(2-chloroanilino)-1,3,5-triazine), Triflumizole ((E)-4-chloro-α,α,α-tritrifluoro-N-(1-imidazole-1-yl-2-propoxyethylidane)-O-toluidine), Metalaxyl (methyl N-(2 -methoxyacetyl)-N-(2,6-xylyl)-D, L-alaninate), Bitertanol (all-rac-1-(biphenyl-4-yloxy)-3,3 -dimethyl-1- (1H-1,2,4-triazol-1-yl) butane-2-ol) , Triadimefon (1-(4-chlorophenoxy)-3,3-dimethyl-1-(1H-1,2,4-triazol-1-yl)-2-butanone), Isoprothiolane (diisopropyl 1,3-dithiolane-2-ylidenemalonate), Daconil (tetrachloro-isophthalonitrile), Pansoil (5-ethoxy-3-trichloromethyl-1,2,4-thiadiazole), Rabcide (4,5,6,7-tetrachlorophthalolide), Kitazin P (0,0-diisopropyl-S-benzylthiophosphate), Hinosan (0-ethyl-S,S-diphenyl phosphorodithioate), Probenazol (3-allyloxy-1,2-benzisothiazole-1,1-dioxide) and Captan (N-trichloromethylthiotetrahydrophthalimide).

In a further aspect, the pesticide is a nematicide. Examples of nematicides include, but are not limited to, aldoxycarb, benclothiaz, cadusafos, DBCP, dichlofenthion, DSP, ethoprophos, fenamiphos, fensulfothion, fluazaindolizine, fluensulfone, fosthiazate, fosthietan, imicyafos, isamidofos, isazofos, oxamyl, thiaxazafen, thionazin, and tioxazafen,

In a further aspect, the pesticide is an herbicide. Examples of herbicides include, but are not limited to, 2,4-PA, CAT, MCPP, MCP, isopropylamine salt, MDBA, SAP, asulam, amiprofos-methyl, alachlor, isoxaben, imazaquin ammonium, imazosulfuron, ethoxysulfuron, endothal disodium salt, oxadiargyl, oxaziclomefone, orizalin, orthobencarb, cafenstrole, Xanthomonas campestris pv. poas, cyanazine, cyclosulfamron, dithiopyr, siduron, cinosulfuron, cinmethylin, thenylchlor, triaziflam, triclopyr, trifloxysulfuron sodium salt, napropamide, halosulfuron methyl, pyrifenox, pyributicarb, butamifos, flazasulfuron, prodiamine, propyzamide, florasulam, bethrodine, pendimethalin, mecoprop P calcium salt, methyldaimuron, metsulfuron-methyl, lenacil, diflufenican, and thiazopyr.

In a further aspect, the herbicide is an auxin herbicide. Examples of auxin herbicides include, but are not limited to, 2,4-dichlorophenoxyacetic acid (2,4-D), α-naphthalene acetic acid (α-NAA), 2-methoxy-3,6-dicholorobenzoic acid (dicamba), 4-amino-3,5,6-trichloropicolionic acid (tordon or picloram), 2,4,5-trichlorophenoxyacetic acid (2,4,5-T), indole-3-acetic acid (IAA), 4-chloroindole-3-acetic acid (4-Cl-IAA), 2-phenylacetic acid (PAA), indole-3-butyic acid (IBA), and indole-3-propionic acid (IPA). In a still further aspect, the auxin herbicide is dicamba.

In a further aspect, the herbicide is selected from dicamba, tricamba, 4-amino-6-tert-butyl-3-(methylthio)-as-triazine-5(4H), chloramben, 2,3,6-dichlorobenzoic acid, bispyribac, pyriminobac, pyrithiobac, chlorthal, aminopyralid, clopyralid, florpyrauxifen, halauxifen, picloram, quinclorac, and quinmerac.

### 4. STRUCTURE

In one aspect, disclosed are compositions having a structure represented by a formula:

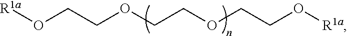

wherein n is an integer selected from 6 to 99; and wherein each of R^{1a} and R^{1b} is independently selected from the residue of the herbicide and a hydrogen, provided that at least one of R^{1a} and R^{1b} is the residue of the pesticide.

In one aspect, disclosed are compositions having a structure represented by a formula:

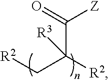

wherein n is an integer selected from 6 to 99; wherein Z is a dicamba residue; wherein R² is selected from —CO₂H and —CO₂(C1-C4 alkyl); and wherein R³ is selected from hydrogen, halogen, —NO₂, —CN, and C1-C4 alkyl.

In a further aspect, the disclosed composition has a structure represented by a formula:

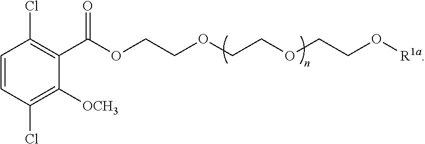

In a further aspect, the disclosed composition has a structure represented by a formula:

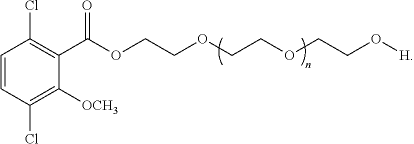

In a further aspect, the disclosed composition has a structure represented by a formula:

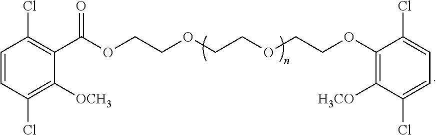

In a further aspect, the disclosed composition has a structure represented by a formula:

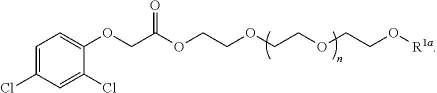

In a further aspect, the disclosed composition has a structure represented by a formula:

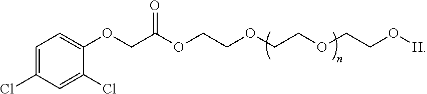

In a further aspect, the disclosed composition has a structure represented by a formula:

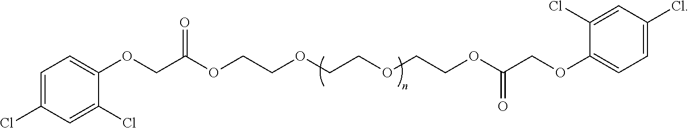

In a further aspect, the disclosed composition has a structure represented by a formula:

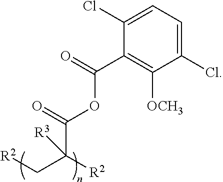

In a further aspect, the disclosed composition has a structure represented by a formula:

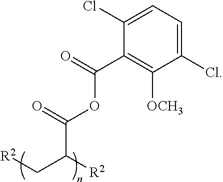

In one aspect, n is an integer selected from 6 to 99. In a further aspect, n is an integer selected from 6 to 90. In a still further aspect, n is an integer selected from 6 to 80. In yet a further aspect, n is an integer selected from 6 to 70. In an even further aspect, n is an integer selected from 6 to 60. In a still further aspect, n is an integer selected from 6 to 50. In yet a further aspect, n is an integer selected from 6 to 40. In an even further aspect, n is an integer selected from 6 to 30. In a still further aspect, n is an integer selected from 6 to 20. In yet a further aspect, n is an integer selected from 6 to 10. In an even further aspect, n is an integer selected from 10 to 99. In a still further aspect, n is an integer selected from 20 to 99. In yet a further aspect, n is an integer selected from 30 to 99. In an even further aspect, n is an integer selected from 40 to 99. In a still further aspect, n is an integer selected from 50 to 99. In yet a further aspect, n is an integer selected from 60 to 99. In an even further aspect, n is an integer selected from 70 to 99. In a still further aspect, n is an integer selected from 80 to 99. In yet a further aspect, n is an integer selected from 90 to 99.

### a. Z Groups

In one aspect, Z is a dicamba residue. In a further aspect, Z has a structure:

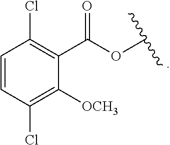 [SMILES: *OC(=O)c1c(Cl)ccc(Cl)c1OC]

### b. R^{1A} and R^{1B} Groups

In one aspect, each of R^{1a} and R^{1b} is independently selected from a residue of the herbicide and a hydrogen. In a further aspect, R^{1a} is a residue of an herbicide. In a still further aspect, R^{1b} is a residue of an herbicide. In yet a further aspect, each of R^{1a} and R^{1b} is a residue of a herbicide.

In a further aspect, R^{1a} is hydrogen. In an even further aspect, R^{1b} is hydrogen.

### c. R² Groups

In one aspect, R² is selected from —CO₂H and —CO₂(C1-C4 alkyl). In a further aspect, R² is selected from —CO₂H, —CO₂CH₃, —CO₂CH₂CH₃, —CO₂CH₂CH₂CH₃, and —CO₂CH(CH₃)₂. In a still further aspect, R² is selected from —CO₂H, —CO₂CH₃, and —CO₂CH₂CH₃. In yet a further aspect, R² is selected from —CO₂H and —CO₂CH₃.

In a further aspect, R² is —CO₂H.

In various aspects, R² is —CO₂(C1-C4 alkyl). In a further aspect, R² is selected from —CO₂CH₃, —CO₂CH₂CH₃, —CO₂CH₂CH₂CH₃, and —CO₂CH(CH₃)₂. In a still further aspect, R² is selected from —CO₂CH₃ and —CO₂CH₂CH₃. In yet a further aspect, R² is —CO₂CH₃.

### d. R³ Groups

In one aspect, R³ is selected from hydrogen, halogen, —NO₂, —CN, and C1-C4 alkyl. In a further aspect, R³ is selected from hydrogen, —Cl, —F, —NO₂, —CN, methyl, ethyl, n-propyl, and isopropyl. In a still further aspect, R³ is selected from hydrogen, —Cl, —F, —NO₂, —CN, methyl, and ethyl. In yet a further aspect, R³ is selected from hydrogen, —Cl, —F, —NO₂, —CN, and methyl.

In a further aspect, R³ is hydrogen.

In various aspects, R³ is selected from hydrogen and halogen. In a further aspect, R³ is selected from hydrogen, —Cl, —F, and —Br. In a still further aspect, R³ is selected from hydrogen, —Cl, and —F. In yet a further aspect, R³ is selected from hydrogen and —F.

In one aspect, R³ is selected from hydrogen and C1-C4 alkyl. In a further aspect, R³ is selected from hydrogen, methyl, ethyl, n-propyl, and isopropyl. In a still further aspect, R³ is selected from hydrogen, methyl, and ethyl. In yet a further aspect, R³ is selected from hydrogen and methyl.

### 5. Optional Additives

In a further aspect, the composition further comprises an additive. The additive can be, for example, an agronomically suitable excipients such as surfactants, solvents, pH modifiers, viscosity modifiers (rheology modifiers), crystallisation inhibitor, antifoam agents, dispersing agents, wetting agents, humectants, emulsifiers, anticaking agent, suspending agents, spray droplet modifiers, pigments, antioxidants, UV protectants, compatibilizing agents, sequestering agents, neutralizing agents, corrosion inhibitors, dyes, odorants, spreading agents, penetration aids, lubricants, sticking agents, thickening agents, freezing point depressants, antimicrobial agents, and the like. The composition content of these auxiliary excipients is not particularly limiting and may be determined by a skilled technician in the art according to the conventional protocols.

In a further aspect, the surfactants that can be additionally added to the compositions are selected from nonionic and/or anionic surfactants.

Examples of nonionic surfactants include, but are not limited to, alkylphenol alkoxylates, alcohol alkoxylates, fatty amine alkoxylates, polyoxyethylene glycerol fatty acid esters, castor oil alkoxylates, fatty acid alkoxylates, fatty amide alkoxylates, fatty polydiethanolamides, lanolin ethoxylates, fatty acid polyglycol esters, isotridecyl alcohol, fatty amides, methylcellulose, fatty acid esters, alkyl polyglycosides, glycerol fatty acid esters, polyethylene glycol, polypropylene glycol, polyethylene glycol/polypropylene glycol block copolymers, polyethylene glycol alkyl ethers, polypropylene glycol alkyl ethers, polyethylene glycol/polypropylene glycol ether block copolymers (polyethylene oxide/polypropylene oxide block copolymers) and mixtures thereof. Still additional examples of nonionic surfactants include, but are not limited to, fatty alcohol ethoxylates, alkyl polyglycosides, glycerol fatty acid esters, castor oil alkoxylates, fatty acid alkoxylates, fatty amide alkoxylates, lanolin ethoxylates, fatty acid polyglycol esters and ethylene oxide/propylene oxide block copolymers and mixtures thereof

Examples of anionic surfactants include, but are not limited to, alkylaryl sulfonates, phenyl sulfonates, alkyl sulfates, alkyl sulfonates, aryl alkyl sulfonates, alkyl ether sulfates, alkylaryl ether sulfates, alkyl polyglycol ether phosphates, polyaryl phenyl ether phosphates, alkyl sulfosuccinates, olefin sulfonates, paraffin sulfonates, petroleum sulfonates, taurides, sarcosides, salts of fatty acids, alkylnaphthalenesulfonic acids, naphthalenesulfonic acids and lignosulfonic acids, condensates of sulfonated naphthalenes with formaldehyde or with formaldehyde and phenol and, if appropriate, urea, and also condensates of phenolsulfonic acid, formaldehyde and urea, lignosulfite waste liquors and lignosulfonates, alkyl phosphates, alkylaryl phosphates, for example tristyryl phosphates, and also polycarboxylates, such as, for example, polyacrylates, maleic anhydride/olefin copolymers, including the alkali metal, alkaline earth metal, ammonium and amine salts of the substances mentioned above and mixtures thereof. Still additional examples of anionic surfactants include, but are not limited to, those which carry at least one sulfonate group, and in particular their alkali metal and their ammonium salts and mixtures thereof

In a further aspect, the composition can comprise a pH modifier such as, for example, a buffer. Examples of buffers include, but are not limited to, alkali metal salts of weak inorganic or organic acids, such as, for example, phosphoric acid, boric acid, acetic acid, propionic acid, citric acid, fumaric acid, tartaric acid, oxalic acid and succinic acid.

In a further aspect, the compositions comprise antifoaming agents such as, for example, non-silicone or silicone based antifoaming agents (e.g.., AF-100).

In a further aspect, the compositions comprise a rheology modifier (or a viscosity modifying additive). Examples of rheology modifiers include, but are not limited to, bentonites, attapulgites, polysaccharides, such as xanthan gum and kelzan gum.

In a further aspect, the compositions comprise an antifreeze agent. Examples of antifreeze agents include, for example, liquid polyols such as, for example ethylene glycol, propylene glycol, and glycerol.

In a further aspect, the compositions comprise a dispersing agent. Examples of dispersing agents include, but are not limited to, polyethylene glycol/polypropylene glycol block copolymers, polyethylene glycol alkyl ethers, polypropylene glycol alkyl ethers, polyethylene glycol/polypropylene glycol ether block copolymers, alkylaryl phosphates, for example, tristyryl phosphates, lignosulfonic acids, condensates of sulfonated naphthalenes with formaldehyde or with formaldehyde and phenol and, if appropriate, urea, and also condensates of phenolsulfonic acid, formaldehyde and urea, lignosulfite waste liquors and lignosulfonates, polycarboxylates, such as, for example, polyacrylates, maleic anhydride/olefin copolymers including the alkali metal, alkaline earth metal, ammonium and amine salts of the substances mentioned above.

In a further aspect, the compositions comprise a wetting agent. Examples of wetting agents include, but are not limited to, naphthalenesulfonic acids including their alkali metal, alkaline earth metal, ammonium and amine salts, fatty alcohol ethoxylates, alkyl polyglycosides, glycerol fatty acid esters, castor oil alkoxylates, fatty acid alkoxylates, fatty amide alkoxylates, fatty polydiethanolamides, lanolin ethoxylates and fatty acid polyglycol esters.

In a further aspect, the compositions comprise a humectant such as, for example polyols like sucrose, glycerin or glycerol, triethylene glycol, tripropylene glycol, and propylene glycol.

### C. METHODS OF MAKING AGROCHEMICAL COMPOSITIONS

In one aspect, disclosed are methods for making a disclosed composition. Thus, in various aspects, the method comprises reacting a polymer and a pesticide having a carboxylic acid group, wherein the polymer has a terminal group selected from —OH and —NH₂. In various further aspects, the method comprises polymerizing an acrylate monomer having a structure represented by a formula:

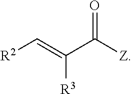

In various further aspects, the method comprises reacting a macromolecule having a molecular weight of at least about 500 g/mol and a length of at least about 10 Angstroms and a pesticide having a carboxylic acid group, wherein the macromolecule has a terminal group selected from —OH and —NH₂.

In a further aspect, the polymer is a polyester. Examples of polymers suitable in the present invention include, but are not limited to, polyethylene terephthalate (PET).

In a further aspect, the polymer has a terminal —OH group. In a still further aspect, the polymer has a terminal —NH₂ group.

In a further aspect, the method comprises reacting a pesticide having a carboxylic acid group. Pesticides are commercially available or prepared by methods known to those skilled in the art. In addition, it is envisioned that the pesticide could be chemically modified to include a carboxylic acid group using methods known to those skilled in the art. Examples of pesticides include, but are not limited to, herbicides, insecticides, insect growth regulators, fungicides, rodenticides, molluscicides, avicides, bactericides, and nematicides. Further examples of pesticides include, but are not limited to, propen-1-ol-3, 2-(ethylamine)-4-(isopropylamino)-6-(methylthio-s-triazine)3-amino-5-triazole, arsenic acid, methyl sulfanilyl carbamate, 2-chloro-4-(ethylamino)-6-(isopropylamino)-s-triazine, (4-chloro-2-butynyl N-3(-chlorophenyl) carbamate, 4-chloro-2-oxobenzothiazolin-3-ylacetic acid, N-butyl-N-ethyl-a,a,a-trifluoro-2,6-dinitro-p-toluidine, [S-(o,o-diisopropyl phosphorodithioate) ester of N-(2-mercaptoethyl) benzene sulfonamide], 3-isopropyl-1H-2,1,3-benzothiadiazin-4-(3H)-one 2,2-dioxide(benzamidooxy) Acetic Acid, methyl-5-(2,4-dichlorophenoxy)-2-nitrobenzoate, 5-bromo-3-sec-butyl-6-methyluracil, 3,5-dibromo-4-hydroxybenzonitrile, hydroxydimethylarsine oxide, D-N-ethyllacetamide carbanilate (ester), 3-amino-2,5-dichlorobenzoic acid, 3-(4-bromo-3-chlorophenyl)-1-methoxy-1-methylurea, methyl-2-chloro-9-hydroxyfluorene-9-carboxylate, 3-[p-(p-chlorophenoxy)phenyl]-1,1-dimethylurea, isopropyl-m-chlorocarbanilate, 2[[4-chloro-6-(ethylamino)-s-triazin-2-yl]Amino]-2-methylpropionitrile, 2-chloro-4-(cyclopropylamino)-6-(isopropylamino)-s-triazine, (2,4-dichlorophenoxy)acetic acid, 2,2-dichloropropionic acid, 4-(2,4-dichlorophenoxy)butyric acid, ethyl m-hydroxycarbanilate carbanilate, 3,6-dichloro-o-anisic acid, 2-(2,4-dichlorophenoxy)propionic acid, N⁴,N⁴-diethyl-a,a,a-trifluoro-3,5-dinitrotoluene-2,4-diamine, 2-sec-butyl-4,6-dinitrophenol 2,4-bis(isopropylamino)-6-(ethylthio)-s-triazine, 3-(3,4-dichlorophenyl)-1,1-dimethylurea, 7-oxabicyclo [2,2,1]heptane-2,3-dicarboxylic acid, 2-chloroethylphosphonic acid, (2,3,6-trichlorophenyl)acetic acid, 1,1-dimethyl-3-phenylurea mono(trichloroacetate), 1,1-dimethyl-3-(a,a,a-trifluoro-m-tolyl)urea, n-butyl-9-hydroxyfluorene-(9)-carboxylate, N-(phosphonomethyl) glycine, N,N-bis(phosphonomethyl) glycine, 2-methoxy-4-ethylamino-6-sec-butylamino-s-triazine, 4-hydroxy-3,5-diiodobenzonitrile, 3-(m-hydroxyphenyl)-1,1-dimethylurea, 3-(3,4-dichlorophenyl)-1-methoxy-1-methylurea methanearsonic acid, N-[3-[(1,1,1-trifluoromethylsulfonyl)Amino]-4-methylphenyl]acetamide, 1,1,1-trifluoro-N-[2-methyl-4-(phenylsulfonyl)phenyllmethanesulfonamide, 2-methyl-4-chlorophenoxyacetic acid, 4[(4-chloro-o-tolyl)oxy]butyric acid, 2-[(4-chloro-o-tolyl]oxy]propionic acid, 4-amino-6-tert-butyl-3-(methylthio)-as-triazin-5(4H)one, 1,2-dihydro 3,6-pyridazinedione, 3-(p-chlorophenyl)-1,1-dimethylurea, 1-naphthalene acetic acid, N-1-naphthylphthalamic acid, 6-tert-butyl-3-isopropylisoxazolo-[5,4-d]pyrimidin-4(5H)-one, 3-(hexahydro-4,7-methanoindan-5-yl)-1,1-dimethylurea, 4-chloro-5-(methylamino)-2-(a,a,a-trifluoro-m-tolyl)-3-(21t)-pyridazinone, 3,5-dinitro N⁴,N⁴-dipropylsulfanilamide, methyl m-hydroxycarbanilate m-methylcarbanilate, 4-amino-3,5-6-trichloropicolinic acid, p-chlorophenyl N-methylcarbamate, 2,4-bis(isopropylamino)-6-methoxy-s-triazine, 2,4-bis(isopropylamino)-6-(methylthio)-s-triazine, N,-(1,1-dimethylpropynyl)-3,5-dichlorobenzamide, 3′,4′-dichloropropionanilide, 2-chloro-4,6-bis(isopropylamino)-s-triazine, isopropyl carbanilate, 5-amino-4-chloro-2-phenyl-3(2H)-pyridazinone, 1-(2-methylcyclohexyl)3-phenylurea, 2-(2,4,5-trichlorophenoxy)propionic, 2-chloro-4,6-bis(ethylamino)-s-triazine, (2,4,5-trichlorophenoxy)acetic acid, 2,3,6-trichlorobenzoic acid, trichloroacetic acid, 3-tert-butyl-5-chloro-6-methyluracil, 2-chloro-4-ethylamino-6-tert-butylamino-s-triazine, 2,6-di-tert-butyl-p-tolyl methylcarbamate, 2-methylthio-4-ethylamino-6-tert-butylamino-s-triazine, 2,3,5-triiodobenzoic acid, -s-(2,3,3,-trichloroallyl)diisopropylthiocarbamate, -s-propyl dipropylthiocarbamate, acroeline phenylhydrazone, 2-amino-3-chloro-1,4-naphthoquinone, 4-amino pteroylglutamic acid, p-tert-amyl phenol, 2-(3′-pyridyl) piperidine, 2,4-dichloro-6-(2-chloroanil-o)-1,3,5 triazine, 1-decanol, 1-(1-naphthyl)-2-thiourea, 2-iodobenzanilide, 1,4-benzoquinone-1-benzoyl-hydrozone-4-oxime, 4-chloro-3,5-xylenol, n-butyl-p-hydroxybenzoate, benzoyl-8-hydroxyquinoline salicylate, 3-(sec-butyl) phenyl-N-methylcarbamate, 3,5-dibromo-4-hydroxybenzaldehyde O-(2,4-dinitrophenyl) oxime, 2-bromo-4′-hydroxyacetophenone, isopropyl 4,4′-dibromobenzilate, 3,5-dibromo-4-hydroxybenzonitrile, 2-ethyl-2-butyl-1,3-propanediol, 1-naphthyl methylcarbamate, 2,3-dihydro-2,2-dimethyl-benzofuran-7-yl-methylcarbamate, chlorobenzenesulfonamide, monochloroacetic acid, cis-3-chloroacrylic acid, 3-amino-2,5-dichlorobenzoic acid, 2,2′-thiobis(4-chloro-6-methylphenol), 3-(4-bromo-3-chlorophenyl)-1-methoxy-1-methylurea, 1-methyl-2-propynyl-m-chlorocarbanilate, ethyl 4,4′-dichlorobenzilate, 4-chloro-m-cresol, 4-chloro-2-cyclopentyl phenol, 5-chloro-4-methyl-2-propionamidothiazole, 2,2,3-trichloropropionic acid, isopropyl 4,4′-dichlorobenzilate, 6-chloro thymol, 3,5-dichloro-4-hydroxybenzonitrile, o-benzyl-p-chlorophenol, 3-(a-acetonyl-4-chlorobenzyl)-4-hydroxycoumarin, 2-(3-chlorophenoxy)a-propionamide, 2-(3-chlorophenoxy) propionic acid, 2-chlorophenyl-N-methylcarbamate, 2-(4-chlorophenoxy) propionic acid, o-cresol, m-cresol, p-cresol, a-cyano-B-(2,4-dichloro)-cinnamie acid, N-cyclohexyl 2,5-dimethyl-3-furamide, 3-(4-cyclopropylphenyl)-1,1-dimethylurea, 3-cyclo-octyl-1,1-dimethylurea, o,o-dimethyl o-p-sulfamoylphenyl phosophorothioate, 2,2-dichloropropionic acid, 1,3-bis(1-hydroxy-2,2,2-trichloroethyl)urea, 3,6-dichloro-2-methoxybenzoic acid, 2,2-methylenebis (4-chlorophenol), 2,4-dichloro phenoxy acetamide, 2-(3,4-dichlorophenoxy)propionic acid, 1,1-bis(p-chlorophenyl)-2,2,2-trichlouethanol, O,O-dimethyl S-(N-methyl-carbamoylmethyl) phosphorodithioate, 4,6-dinitro-o-cresol, 2,4-dinitro-6-cyclohexyl phenol, 2,4-dinitrophenol, 2,5-dichloro-3-nitrobenzoic acid, 2,4 dinitro-6-sec-butylphenol, 2,4-dinitro-6-tert-butylphenol, 1,1-bis(p-chlorophenyl)ethyl carbinol fluoroacetamide, fluoroacetanilide, 3-hydroxy-5-methylisoxazoe, 2-hydroxymethyl-4-chlorophenyloxyacetic acid, 3-inddylpropionic acid, 4-chloro-2-methylphenoxy acetic acid, 4-(4-chloro-2-methylphenoxy)butyric acid, 3-methyl-2,4-dinitro-6-tertbutyl phenol, bishydroxy coumarin, methyl p-hydroxybenzoate, cyclopentane carboxylic acid, B-naphthol, a,a-bis (p-chlorophenyl)-3-pyridine-methanol, nonylic acid, 2,3,4,5,6-pentachlorobenzylalcohol, pentachlorophenol, 2-phenylcyclohexanol, 2-hydroxy diphenyl, N-phenyl-N′-3-thiolane-1-dioxide hydrazide, 4-amino-3,5,6-trichloropicdinic acid, 2-hydroxybenzhydroxamic acid, 2,4 hexadienoic acid, 1,1′-methylenedi-2-naphthol, 2,3,6-trichlorobenzoic acid, 3,4′,5-tribromosahcylanilide, 3-trifluoromethyl-4-nitrophenol, 2,3,5-triiodobenzoic acid, 3,5,6-trichloro-2-methoxybenzoic acid, 2,4,6-trichlorophenol, 2,4,5-trichlorophenol, 2-(hydroxymethyl)-2-nitro-1,3-propanediol, 2,3,6-trichlorobenzyloxypropanol, 10-undecenoic acid, and 2,4-dimethyl phenol.

In a further aspect, the pesticide is an herbicide.

In a further aspect, the herbicide is an auxin herbicide. Examples of auxin herbicides include, but are not limited to, 2,4-dichlorophenoxyacetic acid (2,4-D), α-naphthalene acetic acid (α-NAA), 2-methoxy-3,6-dicholorobenzoic acid (dicamba), 4-amino-3,5,6-trichloropicolionic acid (tordon or picloram), 2,4,5-trichlorophenoxyacetic acid (2,4,5-T), indole-3-acetic acid (IAA), 4-chloroindole-3-acetic acid (4-Cl-IAA), 2-phenylacetic acid (PAA), indole-3-butyic acid (IBA), and indole-3-propionic acid (IPA). In a still further aspect, the auxin herbicide is dicamba.

In a further aspect, the herbicide is selected from dicamba, tricamba, 4-amino-6-tert-butyl-3-(methylthio)-as-triazine-5(4H), chloramben, 2,3,6-dichlorobenzoic acid, bispyribac, pyriminobac, pyrithiobac, chlorthal, aminopyralid, clopyralid, florpyrauxifen, halauxifen, picloram, quinclorac, and quinmerac.

### D. METHODS FOR CONTROLLING PLANT GROWTH

In one aspect, disclosed are methods for controlling plant growth in an environment using a disclosed composition. Thus, in various aspects, the method comprises applying an effective amount of a composition comprising: (a) a non-polymeric residue having a molecular weight of at least about 500 g/mol and a length of at least about 10 Angstroms; or (b) a polymer backbone, and a residue of an herbicide having a carboxylate group, and wherein the residue terminates the non-polymeric residue or the polymer backbone. In various aspects, the method comprises applying an effective amount of a composition having a structure represented by a formula:

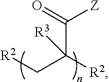

wherein n is an integer selected from 6 to 99; wherein Z is a dicamba residue; wherein R² is selected from —CO₂H and —CO₂(C1-C4 alkyl); and wherein R³ is selected from hydrogen, halogen, —NO₂, —CN, and C1-C4 alkyl.

In a further aspect, the polymer backbone comprises a polyester polymer.

In a further aspect, the polymer backbone comprises a residue of a polymer having an alcohol group. In a further aspect, the polymer backbone comprises a residue of a polymer having an amine group.

In a further aspect, the herbicide is an auxin herbicide. Examples of auxin herbicides include, but are not limited to, 2,4-dichlorophenoxyacetic acid (2,4-D), α-naphthalene acetic acid (α-NAA), 2-methoxy-3,6-dicholorobenzoic acid (dicamba), 4-amino-3,5,6-trichloropicolionic acid (tordon or picloram), 2,4,5-trichlorophenoxyacetic acid (2,4,5-T), indole-3-acetic acid (IAA), 4-chloroindole-3-acetic acid (4-Cl-IAA), 2-phenylacetic acid (PAA), indole-3-butyic acid (IBA), and indole-3-propionic acid (IPA). In a still further aspect, the auxin herbicide is dicamba.

In a further aspect, the herbicide is selected from dicamba, tricamba, 4-amino-6-tert-butyl-3-(methylthio)-as-triazine-5(4H), chloramben, 2,3,6-dichlorobenzoic acid, bispyribac, pyriminobac, pyrithiobac, chlorthal, aminopyralid, clopyralid, florpyrauxifen, halauxifen, picloram, quinclorac, and quinmerac.

In a further aspect, the composition has a structure represented by a formula:

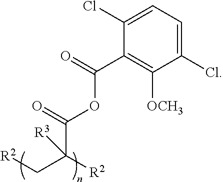

In a further aspect, the composition has a structure represented by a formula:

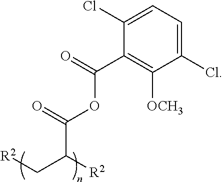

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

### E. EXAMPLES

The following examples are put forth so as to provide those of ordinary skill in the art with a complete disclosure and description of how the devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

### 1. Prophetic Example 1: Develop And Synthesize Polymer-Based Dicamba Formulations

Two polymer-based formulations of dicamba will be synthesized: one involving direct polymerization of an activated dicamba molecule and one involving conjugation of the dicamba molecule to a hydrophilic polymer. Both designs will allow attachment of the dicamba molecules to the large polymer backbone via hydrolysable (degradable) bonds, allowing direct release of the native dicamba molecule onto plant leaves and into the soil.

### a. Pegylate Dicamba Using Various Molecular-Weight Polyethylene Glycol (PEG)

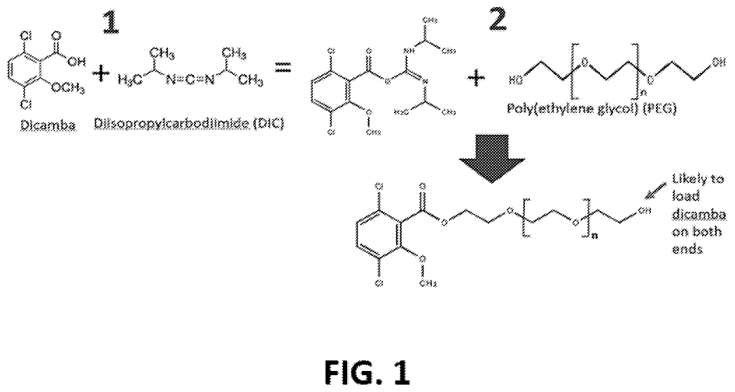

The dicamba molecule will be attached via an ester bond to the endgroups of PEG of various molecular weights (600 Da, 1000 Da, 2000 Da). A two-step chemical reaction involving the activation of the dicamba molecule for esterification with diisopropylcarbodiimide (DIC) and a subsequent reaction with hydroxyl-terminated PEG are outlined in FIG. 1. The resulting PEGylated dicamba molecule (dicamba-PEG) involves attachment of the dicamba molecule on both PEG ends via a hydrolysable ester bond. Use of DIC ensures maximum product yield during esterification. PEG is listed as approved for food and nonfood use on the EPA List of Inert Pesticide Ingredients (mean MW between 194-9,500 amu) (InertFinder. U.S. Environmental Protection Agency (2018)).

### b. Polymerize Dicamba

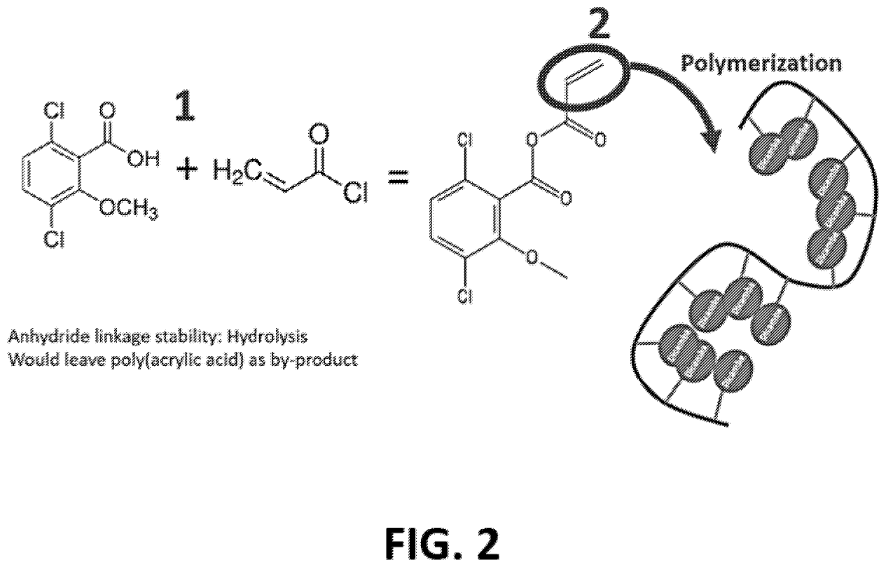

The second polymer formulation of dicamba will involve direct polymerization of an activated dicamba molecule. This polymeric dicamba (poly-dicamba) will exhibit dicamba molecules attached as pendant groups to a carbon polymer backbone via hydrolysable anhydride bonds, allowing release of the active herbicide following spray. To achieve synthesis of poly-dicamba, chemical reactions must be achieved in two steps, outlined in FIG. 2. Upon release of dicamba in the soil or upon plant leaves, a by-product of poly(acrylic acid), an inert polymer with no known effects on plant growth or metabolism. While unable to identify any information regarding current EPA standing, acrylic acid polymer was listed as an “other ingredient for which EPA has sufficient information to reasonably conclude that the current use pattern in pesticide products will not adversely affect public health or the environment,” according to the 2004 EPA List of Inert Pesticide Ingredients (List 4B) (Office of Pesticide Programs. List of Inert Pesticide Ingredients (List 4B). U.S. Environmental Protection Agency (2004)).

### c. Purify Polymer-Based Dicamba Formulations

Following synthesis, byproducts from the chemical reactions will likely be present in the product media and will require purification. Dicamba-PEG will need to be purified using preparative thin layer chromatography plates. The synthesis procedure discussed above (poly-dicamba) should require only dialysis to rid the product of unreacted contaminants. As the dialysis will need to be performed in water, a citrate-phosphate buffer will be utilized to prevent premature hydrolysis of the anhydride bond. Proper dialysis membrane MWCO (2.5 kDa) will be used for all samples. To assess purity of samples, high-performance liquid chromatography profiles will be assessed for the existence of only one peak. Size exclusion chromatography will be utilized to obtain approximate molecular weight for dicamba-PEG, while MALDI-TOF mass spectrometry will be needed to estimate MW of poly-dicamba.

### 2. Prophetic Example 2: Characterize Dicamba Release and Volatilization Behavior From Polymer-Based Dicamba Formulations

Each dicamba formulation will be tested to assess release rates for the dicamba molecules in the presence of water to ensure that no free dicamba is available to volatilize upon spray. Sublimation behavior and volatility of dicamba within the various polymeric formulations will be analyzed.

### a. Examine Release Of Dicamba From Polymer-Based Formulations

As dicamba that is released from the polymer prior to spray application has potential to volatilize and drift during spraying, ensuring that the polymer formulation exhibits proper release kinetics is crucial. As poly-dicamba relies on anhydride bond stability and dicamba-PEG utilizes ester bonds, differences in the hydrolysis release rate are expected. To assess release rate, each formulation will be dissolved in distilled water and placed in a dialysis membrane that is then placed in a water reservoir. Microdialysis will allow diffusion of free dicamba into the reservoir, and released dicamba will be analyzed at regular time intervals utilizing UV spectrophotometry.

### b. Analyze Sublimation Behavior Of Dicamba And Poly-Dicamba

Sublimation behavior analysis requires that dicamba formulations exist in solid form, so both poly-dicamba and dicamba-PEG will be lyophilized immediately after synthesis and subsequent ether precipitation. Each polymeric dicamba formulation and native dicamba powder will be analyzed utilizing differential scanning calorimetry (DSC), which will indicate temperatures of sublimation energy input. Thermogravimetric Analysis (TGA) will then assess mass loss over a temperature range pre-determine from DSC. The combination of the two techniques will allow estimation of dicamba mass loss due to sublimation at various temperatures. This knowledge will allow inferences to be made regarding temperatures and environmental conditions in which the dicamba formulations may be applied to crops.

### c. Assess Volatility Of Polymer-Based Dicamba Formulations

Ultimately, information regarding the tendency of dicamba to volatilize while in an aqueous environment will most accurately reflect spray conditions. Gas chromatography (GC) will be utilized to evaluate volatility potential of each dicamba formulation, native dicamba, and current commercial products (i.e., Banvel, XtendiMax, etc.) in conjunction with a purge-and-trap system. Statistical analysis will determine any differences between the groups or the effect of PEG MW on volatility. If GC-mass spectrometry (GC-MS) is identified on campus, the effect of buffered or salt solutions on reduction of volatility of the dicamba formulations can be assessed.

Without wishing to be bound by theory, poly-dicamba will likely release dicamba at a much faster rate than dicamba-PEG formulations due to the greater propensity of anhydride bonds to hydrolyze when compared to ester bonds. Both dicamba-PEG and poly-dicamba will likely exhibit much lower mass loss due to sublimation than native dicamba and also show much lower levels of volatility.

### 3. Prophetic Example 3: Investigate Herbicidal Activity of the Polymer-Based Dicamba Formulations Under Simulated Spray Conditions

The ability of the polymeric dicamba formulations to retain herbicidal activity will be investigated. As the time of application and herbicide concentration greatly affect weed killing efficacy, studies will be performed evaluating both criteria. Additionally, dicamba-resistant soybeans will be exposed to various concentrations of dicamba formulations to assess whether the plants retain resistance to the polymer formulations.

### a. Test Killing Efficiency Of Dicamba And Polymer-Dicamba Formulations In Broadleaf Weeds

Broadleaf plantain plants will be grown approximately one week following initial leaf emergence (Leaf stage 1). A humidome-like tarp covering will be placed over the plants in order to not affect other plants in the greenhouse from dicamba volatility. Based off of Banvel application concentrations (calculated at 4.36 g/L, 0.60 mg/plant), a pre-determined number of plants that are randomly assigned to study groups will receive treatments of 2400, 600, 150, 37.5, 9.4, 2.3, 0.59, and 0.15 μg/plant of designated dicamba formulation treatments (study groups outlined in Table 1). Images will be taken of each plant daily for up to 14 days (or time of weed kill), and particular attention will be paid to phytotoxic effects like cupping, malformation, epinasty, and necrosis of the leaves. Time to kill and percentage of weeds killed will be analyzed against concentration for each of the treatment groups to determine killing efficiency, optimal application concentrations, and LD₅₀. If desired, the plant locations can be left (not cleaned up) following the study to allow for observation of new weed growth. Such “negligence” will allow for determination of duration of herbicidal activity within the soil.

TABLE 1
Plant Treatment Groups

Dicamba
Dicamba-PEG
Poly-Dicamba
Banvel ®
Xtendimax ® with VaporGrip ®
Water (Negative Control)

Using an approximate LD₅₀ for all formulations determined in the above study (concentration will be the same for all formulations), the different dicamba formulation treatments will be applied to broadleaf plantain plants at differing growth stages (Seeding, crop emergence, Week 1 (Leaf Stage 1), Week 2 (Leaf Stage 2), Week 3 (Leaf Stage 3), Week 4 (Leaf Stages 4-5), and Week 5 (Leaf Stage 6)) to determine optimal application time. Plants will be monitored as described above with images taken regularly following treatment.

### b. Test Soybean Plant Resistance To Dicamba And Polymer-Dicamba Formulations And Subsequent Growth

Dicamba-resistant soybeans (Roundup Ready 2 Xtend, Monsanto) will be grown for approximately one week (all plants under 4 in. tall). All formulations will be applied at 4×, 2×, and 1× application concentrations to a pre-determined number of randomly assigned plants. Daily images will be taken of the plants and leaves. Plant height will be charted daily to assess any potential stunted growth.

Without wishing to be bound by theory, polymer dicamba formulations will likely exhibit similar weed killing efficiency to commercially-marketed products and/or native dicamba; however, a greater duration of herbicidal activity is likely due to the extended release characteristics of the formulations. Dicamba-resistant soybeans will likely not exhibit any greater stunted growth with the polymeric formulations than with other formulations.

The foregoing is illustrative of the present invention, and is not to be construed as limiting thereof. The invention is defined by the following claims, with equivalents of the claims to be included therein.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising:
(a) a non-polymeric residue having a molecular weight of at least about 500 g/mol and a length of at least about 10 Angstroms; or
(b) a polymer backbone,
and a residue of a pesticide having a carboxylate group, wherein the residue terminates the non-polymeric residue or the polymer backbone.

2. The composition of claim 1, wherein the polymer backbone comprises a polyester polymer.

3. The composition of claim 1, wherein the polymer backbone comprises a residue of a polymer having an alcohol group.

4. The composition of claim 1, wherein the pesticide is selected from an herbicide, an insecticide, an insect growth regulator, a fungicide, a rodenticide, a molluscicide, an avicide, a bactericide, and a nematicide.

5. The composition of claim 1, wherein the pesticide is an herbicide.

6. The composition of claim 5, wherein the herbicide is an auxin herbicide.

7. The composition of claim 6, wherein the auxin herbicide is selected from 2,4-dichlorophenoxyacetic acid (2,4-D), α-naphthalene acetic acid (α-NAA), 2-methoxy-3,6-dicholorobenzoic acid (dicamba), 4-amino-3,5,6-trichloropicolionic acid (tordon or picloram), 2,4,5-trichlorophenoxyacetic acid (2,4,5-T), indole-3-acetic acid (IAA), 4-chloroindole-3-acetic acid (4-Cl-IAA), 2-phenylacetic acid (PAA), indole-3-butyic acid (IBA), and indole-3-propionic acid (IPA).

8. The composition of claim 6, wherein the auxin herbicide is dicamba.

9. The composition of claim 5, wherein the herbicide is selected from dicamba, tricamba, 4-amino-6-tert-butyl-3-(methylthio)-as-triazine-5(4H), chloramben, 2,3,6-dichlorobenzoic acid, bispyribac, pyriminobac, pyrithiobac, chlorthal, aminopyralid, clopyralid, florpyrauxifen, halauxifen, picloram, quinclorac, and quinmerac.

10. The composition of claim 1, wherein the residue terminates the polymer backbone on one end of the polymer backbone.

11. The composition of claim 1, wherein the residue terminates the polymer backbone on both ends of the polymer backbone.

12. The composition of claim 1, wherein the residue and the polymer backbone are linked via an anhydride or an ester.

13. The composition of claim 1, wherein the composition has a structure represented by a formula: 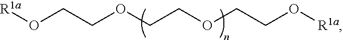
wherein n is an integer selected from 6 to 99; and
wherein each of R^{1a} and R^{1b} is independently selected from the residue of the herbicide and a hydrogen, provided that at least one of R^{1a} and R^{1b} is the residue of the pesticide.

14. A method for making the composition of claim 1, the method comprising reacting a polymer and a pesticide having a carboxylic acid group, wherein the polymer has a terminal group selected from —OH and —NH₂.

15. The method of claim 14, wherein the polymer is a polyester.

16. The method of claim 15, wherein the polyester is polyethylene terephthalate (PET).

17. The method of claim 14, wherein the pesticide is an herbicide.

18. The method of claim 17, wherein the herbicide is an auxin herbicide.

19. The method of claim 17, wherein the herbicide is dicamba.

20. The method of claim 14, wherein the polymer has a terminal —OH group.

21. A method for controlling plant growth in an environment, the method comprising applying an effective amount of a composition comprising:
(a) a non-polymeric residue having a molecular weight of at least about 500 g/mol and a length of at least about 10 Angstroms; or
(b) a polymer backbone,
and a residue of an herbicide having a carboxylate group, and wherein the residue terminates the non-polymeric residue or the polymer backbone.

22. A composition having a structure represented by a formula: 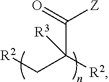
wherein n is an integer selected from 6 to 99;
wherein Z is a dicamba residue;
wherein R² is selected from —CO₂H and —CO₂(C1-C4 alkyl); and
wherein R³ is selected from hydrogen, halogen, —NO₂, —CN, and C1-C4 alkyl.

23. A method for making the composition of claim 22, the method comprising polymerizing an acrylate monomer having a structure represented by a formula:

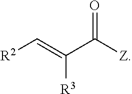

1. A method for controlling plant growth in an environment, the method comprising applying an effective amount of the composition of claim 22.
